(19) United States
(12) Patent Application Publication
(10) Pub. No.: US 2021/0172903 A1
(43) Pub. Date: Jun. 10, 2021

(54) SENSOR ELEMENT FOR GAS SENSOR

(71) Applicant: NGK INSULATORS, LTD., Nagoya-shi (JP)

(72) Inventor: Ryo ONISHI, Iwakura-shi (JP)

(21) Appl. No.: 17/109,209

(22) Filed: Dec. 2, 2020

(30) Foreign Application Priority Data
Dec. 10, 2019 (JP) 2019-222909

(51) Int. Cl. G01N 27/407; G01N 27/41; G01N 27/406

(52) U.S. Cl. CPC G01N 27/4077; G01N 27/4071; G01N 27/4067; G01N 27/41

(57) ABSTRACT

A sensor element includes an element base and a leading-end protective layer disposed around an outer periphery in a predetermined range at least including an end surface having a gas inlet, and being a porous layer including one or more unit layers, and a thickness Tⱼ (j=1 to n: n is a natural number) in μm of a j-th unit layer from a side of the element base on the end surface, a porosity ρⱼ in % of the j-th unit layer, and a distance Lₑ in mm from the heater to the end surface of the element base satisfy a predetermined inequality on an end surface of the leading-end protective layer.

### CROSS-REFERENCE TO RELATED APPLICATION

The present application claims priority from Japanese application JP 2019-222909, filed on Dec. 10, 2019, the contents of which is hereby incorporated by reference into this application.

### BACKGROUND OF THE INVENTION

### Field of the Invention

The present invention relates to a sensor element for a gas sensor, and, in particular, to a surface protective layer thereof.

### Description of the Background Art

As a gas sensor for determining concentration of a desired gas component contained in a measurement gas, such as an exhaust gas from an internal combustion engine, a gas sensor that includes a sensor element made of an oxygen-ion conductive solid electrolyte, such as zirconia (ZrO₂), and including some electrodes on the surface and the inside thereof has been widely known. As the sensor element, a sensor element having an elongated planar shape and comprising a protective layer formed of a porous body (porous protective layer) in an end portion in which a part for introducing the measurement gas is provided has been known (see Japanese Patent Application Laid-Open No. 2016-65852, for example).

The protective layer is provided to the surface of the sensor element to secure water resistance of the sensor element when the gas sensor is in use. Specifically, the protective layer is provided to prevent, in a case where water droplets adhere to the surface of the sensor element in a state of being heated by a heater located inside the sensor element, water-induced cracking of the sensor element under the action of thermal shock caused by heat (cold) from the water droplets on the sensor element.

In a case where the protective layer is provided to the planar sensor element as disclosed in Japanese Patent Application Laid-Open No. 2016-65852, a portion of the protective layer farther from the heater tends to be more vulnerable to thermal shock than a portion of the protective layer closer to the heater, and thus water resistance might vary with location.

One possible measure is an increase in thickness of the protective layer to improve thermal shock resistance, but the increase in thickness leads to reduction in responsiveness and temperature rise performance of the sensor element. In particular, in a case where a gas inlet through which the measurement gas is introduced into the sensor element is provided in a leading end surface of the element, an excessive increase in thickness of the protective layer covering the gas inlet is not preferable as it leads to noticeable reduction in responsiveness.

### SUMMARY

The present invention relates to a sensor element for a gas sensor, and is, in particular, directed to a configuration of a surface protective layer thereof.

According to the present invention, a sensor element for a gas sensor includes: an element base being a ceramic structure, the element base having an end surface having a gas inlet through which a measurement gas is introduced into the element base, and including a sensing part for sensing a gas component to be measured and a heater for heating the sensor element; and a leading-end protective layer disposed around an outer periphery of the element base in a predetermined range at least including the end surface, and being a porous layer including one or more unit layers, wherein the leading-end protective layer is provided on the end surface to satisfy

$$\frac{1}{100000} \sum \frac{{T}_{j} \cdot {ρ}_{j}}{{L}_{e}} > 0.05 ( j = 1 \sim n )$$

where Tⱼ (j=1 to n: n is a natural number) is a thickness in μm of a j-th unit layer of the leading-end protective layer from a side of the element base on the end surface, ρᵢ is a porosity in % of the j-th unit layer, and Lₑ is a distance in mm from the heater to the end surface.

The thickness of a portion in which the gas inlet is provided of the leading-end protective layer surrounding a portion of the element base in which the temperature becomes high when the gas sensor is in use is thereby determined so that the porosity and the distance from the heater satisfy the predetermined inequality, so that good water resistance of the portion of the sensor element can be secured without causing reduction in responsiveness.

The sensor element preferably has an elongated planar shape, and the end surface is preferably a surface on a side of one leading end portion in a longitudinal direction of the sensor element.

In this case, in the sensor element including the element base having the gas inlet at a leading end thereof, good water resistance of the leading end portion can be secured without causing reduction in responsiveness.

It is thus an object of the present invention to provide a sensor element for a gas sensor including a protective layer having a thickness in accordance with desired water resistance on an end surface having a gas inlet.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic external perspective view of a sensor element 10;

FIG. 2 is a schematic view illustrating a configuration of a gas sensor 100 including a cross-sectional view taken along a longitudinal direction of the sensor element 10;

FIG. 3 illustrates the gas sensor 100 in a case where a leading-end protective layer 2 has a two-layer configuration of an inner leading-end protective layer 2a and an outer leading-end protective layer 2b;

FIG. 4 is a flowchart of processing at the manufacture of the sensor element 10;

FIG. 5 illustrates a case where the leading-end protective layer 2 has the two-layer configuration, and has a non-uniform thickness;

FIG. 6 is a plot of a result of evaluation of water resistance according to Example 1 shown in Table 1 against a leading end thickness index value; and

FIG. 7 is a plot of a result of evaluation of water resistance according to Example 2 shown in Table 2 against the leading end thickness index value along with the result of evaluation according to Example 1.

### DESCRIPTION OF THE PREFERRED EMBODIMENTS

<Overview of Sensor Element and Gas Sensor>

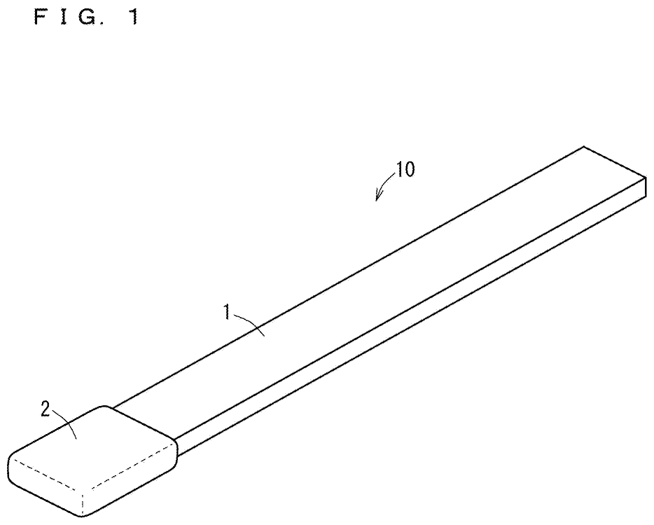

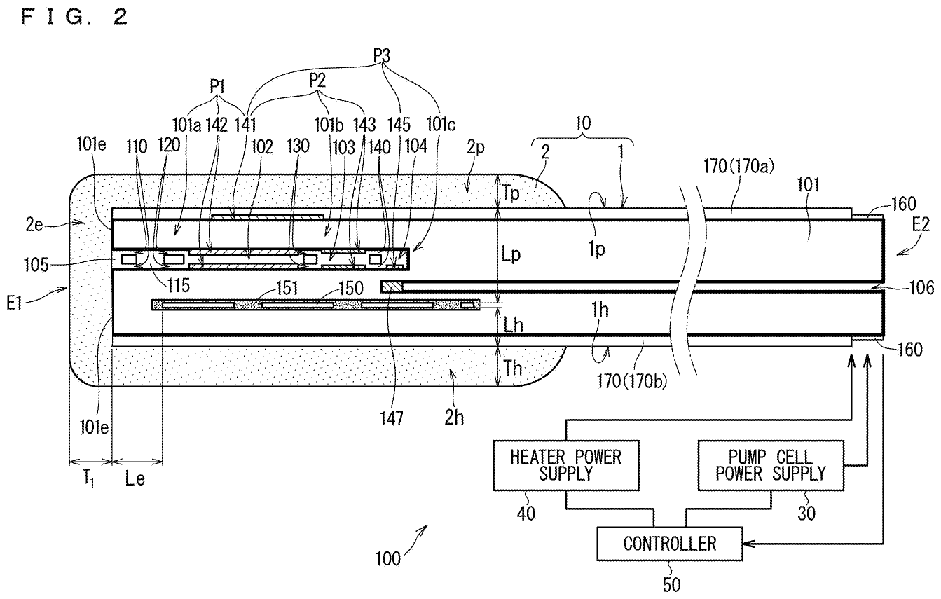

FIG. 1 is a schematic external perspective view of a sensor element (gas sensor element) 10 according to an embodiment of the present invention. FIG. 2 is a schematic view illustrating a configuration of a gas sensor 100 including a cross-sectional view taken along a longitudinal direction of the sensor element 10. The sensor element 10 is a ceramic structure as a main component of the gas sensor 100 sensing a predetermined gas component in a measurement gas, and measuring concentration thereof. The sensor element 10 is a so-called limiting current gas sensor element.

In addition to the sensor element 10, the gas sensor 100 mainly includes a pump cell power supply 30, a heater power supply 40, and a controller 50.

As illustrated in FIG. 1, the sensor element 10 has a configuration in which one end portion of an elongated planar element base 1 is covered with a porous leading-end protective layer 2.

As illustrated in FIG. 2, the element base 1 includes an elongated planar ceramic body 101 as a main structure, main-surface protective layers 170 are provided on two main surfaces of the ceramic body 101, and, in the sensor element 10, the leading-end protective layer 2 is further provided outside both an end surface (a leading end surface 101e of the ceramic body 101) and four side surfaces on a side of one leading end portion. The four side surfaces other than opposite end surfaces in the longitudinal direction of the sensor element 10 (or the element base 1, or the ceramic body 101) are hereinafter simply referred to as side surfaces of the sensor element 10 (or the element base 1, or the ceramic body 101).

The ceramic body 101 is made of ceramic containing, as a main component, zirconia (yttrium stabilized zirconia), which is an oxygen-ion conductive solid electrolyte. Various components of the sensor element 10 are provided outside and inside the ceramic body 101. The ceramic body 101 having the configuration is dense and airtight. The configuration of the sensor element 10 illustrated in FIG. 2 is just an example, and a specific configuration of the sensor element 10 is not limited to this configuration.

The sensor element 10 illustrated in FIG. 2 is a so-called serial three-chamber structure type gas sensor element including a first internal chamber 102, a second internal chamber 103, and a third internal chamber 104 inside the ceramic body 101. That is to say, in the sensor element 10, the first internal chamber 102 communicates, through a first diffusion control part 110 and a second diffusion control part 120, with a gas inlet 105 opening to the outside on a side of one end portion E1 of the ceramic body 101 (the element base 1) (to be precise, communicating with the outside through the leading-end protective layer 2), the second internal chamber 103 communicates with the first internal chamber 102 through a third diffusion control part 130, and the third internal chamber 104 communicates with the second internal chamber 103 through a fourth diffusion control part 140. A path from the gas inlet 105 to the third internal chamber 104 is also referred to as a gas distribution part. In the sensor element 10 according to the present embodiment, the distribution part is provided straight along the longitudinal direction of the ceramic body 101.

The first diffusion control part 110, the second diffusion control part 120, the third diffusion control part 130, and the fourth diffusion control part 140 are each provided as two slits vertically arranged in FIG. 2. The first diffusion control part 110, the second diffusion control part 120, the third diffusion control part 130, and the fourth diffusion control part 140 provide predetermined diffusion resistance to the measurement gas passing therethrough. A buffer space 115 having an effect of buffering pulsation of the measurement gas is provided between the first diffusion control part 110 and the second diffusion control part 120.

An outer pump electrode 141 is provided on an outer surface of the ceramic body 101, and an inner pump electrode 142 is provided in the first internal chamber 102. Furthermore, an auxiliary pump electrode 143 is provided in the second internal chamber 103, and a measurement electrode 145 as a sensing part for directly sensing a gas component to be measured is provided in the third internal chamber 104. In addition, a reference gas inlet 106 which communicates with the outside and through which a reference gas is introduced is provided on a side of the other end portion E2 of the ceramic body 101, and a reference electrode 147 is provided in the reference gas inlet 106.

In a case where a target of measurement of the sensor element 10 is NOx in the measurement gas, for example, concentration of a NOx gas in the measurement gas is calculated by a process as described below.

First, the measurement gas introduced into the first internal chamber 102 is adjusted to have a substantially constant oxygen concentration by a pumping action (pumping in or out of oxygen) of a main pump cell P1, and then introduced into the second internal chamber 103. The main pump cell P1 is an electrochemical pump cell including the outer pump electrode 141, the inner pump electrode 142, and a ceramic layer 101a that is a portion of the ceramic body 101 existing between these electrodes. In the second internal chamber 103, oxygen in the measurement gas is pumped out of the element by a pumping action of an auxiliary pump cell P2 that is also an electrochemical pump cell, so that the measurement gas is in a sufficiently low oxygen partial pressure state. The auxiliary pump cell P2 includes the outer pump electrode 141, the auxiliary pump electrode 143, and a ceramic layer 101b that is a portion of the ceramic body 101 existing between these electrodes.

The outer pump electrode 141, the inner pump electrode 142, and the auxiliary pump electrode 143 are each formed as a porous cermet electrode (e.g., a cermet electrode made of ZrO₂ and Pt that contains Au of 1%). The inner pump electrode 142 and the auxiliary pump electrode 143 to be in contact with the measurement gas are each formed using a material having weakened or no reducing ability with respect to a NOx component in the measurement gas.

NOx in the measurement gas caused by the auxiliary pump cell P2 to be in the low oxygen partial pressure state is introduced into the third internal chamber 104, and reduced or decomposed by the measurement electrode 145 provided in the third internal chamber 104. The measurement electrode 145 is a porous cermet electrode also functioning as a NOx reduction catalyst that reduces NOx existing in an atmosphere in the third internal chamber 104. During the reduction or decomposition, a potential difference between the measurement electrode 145 and the reference electrode 147 is maintained constant. Oxygen ions generated by the above-mentioned reduction or decomposition are pumped out of the element by a measurement pump cell P3. The measurement pump cell P3 includes the outer pump electrode 141, the measurement electrode 145, and a ceramic layer 101c that is a portion of the ceramic body 101 existing between these electrodes. The measurement pump cell P3 is an electrochemical pump cell pumping out oxygen generated by decomposition of NOx in an atmosphere around the measurement electrode 145.

Pumping (pumping in or out of oxygen) of the main pump cell P1, the auxiliary pump cell P2, and the measurement pump cell P3 is achieved, under control performed by the controller 50, by the pump cell power supply (variable power supply) 30 applying a voltage necessary for pumping across electrodes included in each of the pump cells. In a case of the measurement pump cell P3, a voltage is applied across the outer pump electrode 141 and the measurement electrode 145 so that the potential difference between the measurement electrode 145 and the reference electrode 147 is maintained at a predetermined value. The pump cell power supply 30 is typically provided for each pump cell.

The controller 50 detects a pump current Ip2 flowing between the measurement electrode 145 and the outer pump electrode 141 in accordance with the amount of oxygen pumped out by the measurement pump cell P3, and calculates a NOx concentration in the measurement gas based on a linear relationship between a current value (NOx signal) of the pump current Ip2 and the concentration of decomposed NOx.

The gas sensor 100 preferably includes a plurality of electrochemical sensor cells, which are not illustrated, sensing the potential difference between each pump electrode and the reference electrode 147, and each pump cell is controlled by the controller 50 based on a signal detected by each sensor cell.

In the sensor element 10, a heater 150 is buried in the ceramic body 101. The heater 150 is provided, below the gas distribution part in FIG. 2, over a range from the vicinity of the one end portion E1 to at least a location of formation of the measurement electrode 145 and the reference electrode 147. The heater 150 is provided mainly to heat the sensor element 10 to enhance oxygen-ion conductivity of the solid electrolyte forming the ceramic body 101 when the sensor element 10 is in use. More particularly, the heater 150 is provided to be surrounded by an insulating layer 151.

The heater 150 is a resistance heating body made, for example, of platinum. The heater 150 generates heat by being powered from the heater power supply 40 under control performed by the controller 50.

The sensor element 10 according to the present embodiment is heated by the heater 150 when being in use so that the temperature at least in a range from the first internal chamber 102 to the second internal chamber 103 becomes 500° C. or more. In some cases, the sensor element 10 is heated so that the temperature of the gas distribution part as a whole from the gas inlet 105 to the third internal chamber 104 becomes 500° C. or more. These are to enhance the oxygen-ion conductivity of the solid electrolyte forming each pump cell and to desirably demonstrate the ability of each pump cell. In this case, the temperature in the vicinity of the first internal chamber 102, which becomes the highest temperature, becomes approximately 700° C. to 800° C.

In the following description, from among the two main surfaces of the element base 1 (the ceramic body 101), a main surface (or an outer surface of the sensor element 10 having the main surface) which is located on an upper side in FIG. 2 and on a side where the main pump cell P1, the auxiliary pump cell P2, and the measurement pump cell P3 are mainly provided is also referred to as a pump surface 1p, and a main surface (or an outer surface of the sensor element 10 having the main surface) which is located on a lower side in FIG. 2 and on a side where the heater 150 is provided is also referred to as a heater surface 1h. In other words, the pump surface 1p is a main surface closer to the gas inlet 105, the three internal chambers, and the pump cells than to the heater 150, and the heater surface 1h is a main surface closer to the heater 150 than to the gas inlet 105, the three internal chambers, and the pump cells.

A plurality of electrode terminals 160 are formed on the respective main surfaces of the ceramic body 101 on the side of the other end portion E2 to establish electrical connection between the sensor element 10 and the outside. These electrode terminals 160 are electrically connected to the above-mentioned five electrodes, opposite ends of the heater 150, and a lead for detecting heater resistance, which is not illustrated, through leads provided inside the ceramic body 101, which are not illustrated, to have a predetermined correspondence relationship. Application of a voltage from the pump cell power supply 30 to each pump cell of the sensor element 10 and heating by the heater 150 by being powered from the heater power supply 40 are thus performed through the electrode terminals 160.

The sensor element 10 further includes the above-mentioned main-surface protective layers 170 (170a and 170b) on the pump surface 1p and the heater surface 1h of the ceramic body 101. The main-surface protective layers 170 are layers made of alumina, having a thickness of approximately 5 μm to 30 μm, and including pores with a porosity of approximately 20% to 40%, and are provided to prevent adherence of any foreign matter and poisoning substances to the main surfaces (the pump surface 1p and the heater surface 1h) of the ceramic body 101 and the outer pump electrode 141 provided on a side of the pump surface 1p. The main-surface protective layer 170a on the side of the pump surface 1p thus functions as a pump electrode protective layer for protecting the outer pump electrode 141.

In the present embodiment, the porosity is obtained by applying a known image processing method (e.g., binarization processing) to a scanning electron microscope (SEM) image of an evaluation target.

The main-surface protective layers 170 are provided over substantially all of the pump surface 1p and the heater surface 1h except that the electrode terminals 160 are partially exposed in FIG. 2, but this is just an example. The main-surface protective layers 170 may locally be provided in the vicinity of the outer pump electrode 141 on the side of the one end portion E1 compared with the case illustrated in FIG. 2.

<Details of Leading-end Protective Layer>

In the sensor element 10, the leading-end protective layer 2 is provided around an outermost periphery of the element base 1 having a configuration as described above in a predetermined range from the one end portion E1.

The leading-end protective layer 2 is provided in a manner of surrounding a portion of the element base 1 in which the temperature becomes high (up to approximately 700° C. to 800° C.) when the gas sensor 100 is in use, in order to secure water resistance in the portion to thereby suppress the occurrence of cracking (water-induced cracking) of the element base 1 due to thermal shock caused by local temperature reduction upon direct contact of the portion with water.

In the present embodiment, as a result of repeating dropping of a predetermined amount of water onto the leading-end protective layer 2 until any abnormality of a pump current Ip0 occurs before and after dropping, a maximum amount of dropped water not causing the abnormality of the pump current Ip0 is defined as a critical water amount. Whether water resistance is good or not is determined based on the magnitude of a value of the critical water amount. In this case, the term “water resistance” can be used in the sense of the critical water amount.

In addition, the leading-end protective layer 2 is provided to secure poisoning resistance to prevent poisoning substances, such as Mg, from entering into the sensor element 10.

The leading-end protective layer 2 is provided to cover the leading end surface 101e and the four side surfaces of the element base 1 on the side of the one end portion E1 (around an outer periphery of the element base 1 on the side of the one end portion E1). A portion of the leading-end protective layer 2 on a side of the leading end surface 101e is particularly referred to as a leading end portion 2e, a portion of the leading-end protective layer 2 on the side of the pump surface 1p is particularly referred to as a pump surface portion 2p, and a portion of the leading-end protective layer 2 on a side of the heater surface 1h is particularly referred to as a heater surface portion 2h.

The leading-end protective layer 2 is made of alumina to have a porosity of 10% to 40%. The leading-end protective layer 2 is provided as a low thermal conductivity layer having a high porosity to have a function to suppress thermal conduction from the outside to the element base 1.

The leading-end protective layer 2 is formed to have a thickness in light of a positional relationship among the two main surfaces (the pump surface 1p and the heater surface 1h) of the element base 1 as main formation target surfaces, the leading end surface 101e of the ceramic body 101 having the gas inlet 105, and the heater 150 while securing water resistance of the sensor element 10. Details thereof will be described later.

The leading-end protective layer 2 is formed by sequentially thermal spraying (plasma-spraying) a material therefor onto the element base 1. This is to develop an anchoring effect between the element base 1 and the leading-end protective layer 2 to thereby secure bonding (adhesion) of the leading-end protective layer 2 to the element base 1.

<Case where Leading-End Protective Layer has Laminated Structure>

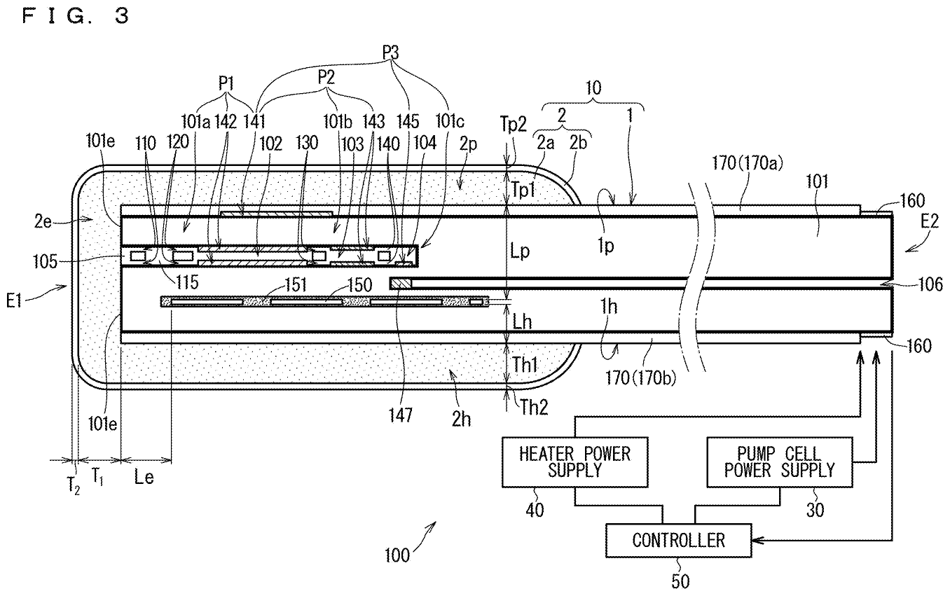

While FIG. 2 illustrates the sensor element 10 including the leading-end protective layer 2 as a single layer, the leading-end protective layer 2 may have a laminated structure in which two or more layers (unit layers) are laminated. FIG. 3 illustrates the gas sensor 100 in a case where the leading-end protective layer 2 has a two-layer configuration of an inner leading-end protective layer 2a and an outer leading-end protective layer 2b. In a case illustrated in FIG. 3, the inner leading-end protective layer 2a is the same layer as the leading-end protective layer 2 of the sensor element 10 illustrated in FIG. 2, and the outer leading-end protective layer 2b is provided to surround the inner leading-end protective layer 2a.

The outer leading-end protective layer 2b is made of alumina, and has a smaller porosity of 10% to 40% than any other layer (the inner leading-end protective layer 2a in the case illustrated in FIG. 3) located inside the outer leading-end protective layer 2b. The leading-end protective layer 2 illustrated in FIG. 3 thus has a configuration in which a layer having a lower thermal conductivity than the outer leading-end protective layer 2b is covered with the outer leading-end protective layer 2b having a smaller porosity than the layer.

As with the inner leading-end protective layer 2a, the outer leading-end protective layer 2b is formed by sequentially thermal spraying (plasma-spraying) a material therefor.

In a case where the leading-end protective layer 2 has the laminated structure as described above, each unit layer is formed to have a thickness in light of the positional relationship among the pump surface 1p, the heater surface 1h, the leading end surface 101e, and the heater 150 while securing water resistance of the sensor element 10. As a result, the leading-end protective layer 2 has a total thickness in light of the positional relationship.

An underlying layer, which is not illustrated, may be formed between the element base 1 and the inner leading-end protective layer 2a to enhance adhesion of the inner leading-end protective layer 2a. In contrast to the inner leading-end protective layer 2a and the like formed by thermal spraying after completion of the element base 1, the underlying layer is formed simultaneously with the element base 1.

<Thickness of Each Portion of Leading-End Protective Layer>

The thickness (the total thickness) of each portion of the leading-end protective layer 2 comprised in the sensor element 10 of the gas sensor 100 according to the present embodiment will be described next. In the present embodiment, the leading-end protective layer 2 is formed to have a thickness in light of the positional relationship among the pump surface 1p, the heater surface 1h, the leading end surface 101e, and the heater 150 as described above.

A relationship between the thickness of the leading-end protective layer 2 on each of the side of the pump surface 1p and the side of the heater surface 1h and the location of the heater 150 will be described first.

The leading-end protective layer 2 is provided so that an inequality (1) below is satisfied in each of the pump surface portion 2p and the heater surface portion 2h, where n (n is a natural number) is the number of unit layers constituting the leading-end protective layer 2, T_{s,i} (i=1 to n) is the thickness in μm of the i-th unit layer from a side of the element base 1 (s=p in a case of the thickness of the pump surface portion 2p, and s=h in a case of the thickness of the heater surface portion 2h), ρᵢ is the porosity in % of the i-th unit layer, and Lₛ is the distance in mm from the heater 150 to the main surface of the element base 1 (s=p in a case of the distance on the side of the pump surface 1p, and s=h in a case of the distance on the side of the heater surface 1h).

$$\frac{1}{100000} \sum \frac{{T}_{s , i} \cdot {ρ}_{i}}{{L}_{s}} > 0.1 ( s = p or h : i = 1 \sim n ) \qquad ( 1 )$$

In this case, good water resistance of the pump surface portion 2p and the heater surface portion 2h is secured. More particularly, water resistance of more than 6 μL can be obtained. A value on a left-hand side of the inequality is hereinafter referred to as a main surface thickness index value.

In a case where the number of unit layers is one (i=1) as in the sensor element 10 illustrated in FIG. 2, a subscript i in the inequality (1) may be omitted. In FIG. 2, T_{p,i}=Tₚ and T_{h,i}=Tₕ. In FIG. 3, T_{p,1}=T_{p,1}, T_{h,1}=Tₕ₁, T_{p,2}=Tₚ₂, and T_{h,2}=Tₕ₂.

The main surface thickness index value is known to have a positive correlation with water resistance. That is to say, the sensor element 10 having a greater main surface thickness index value has better water resistance on each of the side of the pump surface 1p and the side of the heater surface 1h of the sensor element 10. More particularly, a term T_{s,i}·ρᵢ/Lₛ providing the main surface thickness index value is inversely proportional to the distance Lₛ from the heater 150 to the main surface of the element base 1, and is proportional to the thickness T_{s,i} of the unit layer. The inequality (1) thus means that excellent water resistance of the pump surface portion 2p and the heater surface portion 2h can be obtained by providing the unit layers constituting the pump surface portion 2p and the unit layers constituting the heater surface portion 2h respectively on the side of the pump surface 1p and the side of the heater surface 1h so that each unit layer has a thickness in light of the distance Lₛ from the heater 150 to the main surface of the element base 1. This is presumably because, as the distance between the heater 150 and each main surface of the element base 1 increases, a temperature difference inside the sensor element 10 increases, and thermal shock resistance is deteriorated. In a case of the sensor element 10 illustrated in each of FIGS. 2 and 3, the heater surface 1h is closer to the heater 150 than the pump surface 1p is, so that the heater surface portion 2h is formed to have a smaller thickness than the pump surface portion 2p to cause the heater surface portion 2h and the pump surface portion 2p to have equivalent water resistance.

On the other hand, an excessive increase in thickness of the inner leading-end protective layer 2a and the outer leading-end protective layer 2b in each of the pump surface portion 2p and the heater surface portion 2h is not preferable because a thermal load applied to the heater 150 at a temperature rise increases, and, as a result, the sensor element 10 can be cracked. From this perspective, the inner leading-end protective layer 2a preferably has a thickness of 800 μm or less, and the outer leading-end protective layer 2b preferably has a thickness of 400 μm or less in each of the pump surface portion 2p and the heater surface portion 2h.

A relationship between the thickness of the leading-end protective layer 2 on a side of the leading end surface 101e having the gas inlet 105 and the location of the heater 150 will be described next.

The leading-end protective layer 2 is provided on the leading end surface 101e so that an inequality (2) below is satisfied, where n (n is a natural number) is the number of unit layers constituting the leading end portion 2e of the leading-end protective layer 2, Tⱼ (j=1 to n) is the thickness (a size in the longitudinal direction of the element) of the j-th unit layer from the side of the element body 1, ρⱼ is the porosity in % of the j-th unit layer, and Lₑ is the distance in mm from the heater 150 to the leading end surface 101e.

$$\frac{1}{100000} \sum \frac{{T}_{j} \cdot {ρ}_{j}}{{L}_{e}} > 0.05 ( j = 1 \sim n ) \qquad ( 2 )$$

In this case, good water resistance of the leading end portion 2e of the leading-end protective layer 2 is secured. More particularly, water resistance of more than 5 μL can be obtained. A value on a left-hand side of the inequality is hereinafter referred to as a leading end thickness index value.

In a case of a single layer as illustrated in FIG. 2, the leading-end protective layer 2 satisfying the inequality (2) is achieved, for example, when:

300 μm≤T₁≤500 μm;

20%≤ρ₁≤30%; and

0.35 mm≤Lₑ≤1.3 mm

In a case of the two-layer configuration as illustrated in FIG. 3, the leading-end protective layer 2 satisfying the inequality (2) is achieved, for example, when:

300 μm≤T₁≤850 μm;

40%≤ρ₁≤80%;

150 μm≤T₂≤350 μm;

15%≤ρ₂≤40%; and

0.35 mm≤Lₑ≤1.3 mm

As with the main surface thickness index value, the leading end thickness index value is known to have a positive correlation with water resistance. That is to say, the sensor element 10 having a greater leading end thickness index value has better water resistance on the side of the one end portion E1. More particularly, a term Tⱼ·ρⱼ/Lₑ providing the leading end thickness index value is inversely proportional to the distance Lₑ from the heater 150 to the leading end surface 101e, and is proportional to the thickness Tⱼ of the unit layer on the side of the one end portion E1. The inequality (2) thus means that excellent water resistance of the leading end portion 2e can be obtained by providing the unit layers constituting the leading end portion 2e so that each unit layer has a thickness in light of the distance Lₑ from the heater 150 to the leading end surface 101e. This is also presumably because, as the distance between the heater 150 and the leading end surface 101e increases, the temperature difference inside the sensor element 10 increases, and thermal shock resistance is deteriorated.

Viewed in another way, water resistance of the sensor element 10 is secured as long as the thickness of each unit layer is determined so that the inequality (1) is satisfied in each of the pump surface portion 2p and the heater surface portion 2h, and the inequality (2) is satisfied in the leading end portion 2e. It can thus be said that there is less need to provide the leading-end protective layer 2 having an extremely large thickness. In such a case, reduction in responsiveness and temperature rise performance becomes a concern. It can thus be said that the inequalities (1) and (2) are requirements to secure water resistance on the side of the main surfaces and on the side of the one end portion without causing reduction in responsiveness and temperature rise performance.

The leading-end protective layer 2 is preferably provided to have the two-layer configuration of the inner leading-end protective layer 2a and the outer leading-end protective layer 2b as illustrated in FIG. 3, and to satisfy an inequality (3) below.

$$\frac{1}{100000} \sum \frac{{T}_{j} \cdot {ρ}_{j}}{{L}_{e}} > 0.18 ( j = 1 , 2 ) \qquad ( 3 )$$

In this case, better water resistance of the leading end portion 2e is secured. More particularly, water resistance of more than 10 μL can be obtained.

The leading-end protective layer 2 satisfying the inequality (3) is achieved, for example, when:

300 μm≤T₁≤850 μm;

40%≤ρ₁≤80%;

150 μm≤T₂≤350 μm;

15%≤ρ₂≤40%; and

0.35 mm≤Lₑ≤1.3 mm

The leading-end protective layer 2 is more preferably provided on the leading end surface 101e to satisfy an inequality (4) below.

$$\frac{1}{100000} \sum \frac{{T}_{j} \cdot {ρ}_{j}}{{L}_{e}} > 0.25 ( j = 1 , 2 ) \qquad ( 4 )$$

In this case, extremely good water resistance of the leading end portion 2e is secured. More particularly, water resistance of more than 20 μL can be obtained.

The leading-end protective layer 2 satisfying the inequality (4) is achieved, for example, when:

300 μm≤T₁≤850 μm;

50%≤ρ₁≤80%;

250 μm≤T₂≤350 μm;

15%≤ρ₂≤40%; and

0.35 mm≤Lₑ≤1.3 mm

As set forth above, in the sensor element according to the present embodiment, the thickness of a portion in which the gas inlet is provided of the leading-end protective layer surrounding a portion of the element base in which the temperature becomes high when the gas sensor is in use is determined to satisfy the inequality (2), so that good water resistance of the portion of the sensor element can be secured without causing reduction in responsiveness.

<Process of Manufacturing Sensor Element>

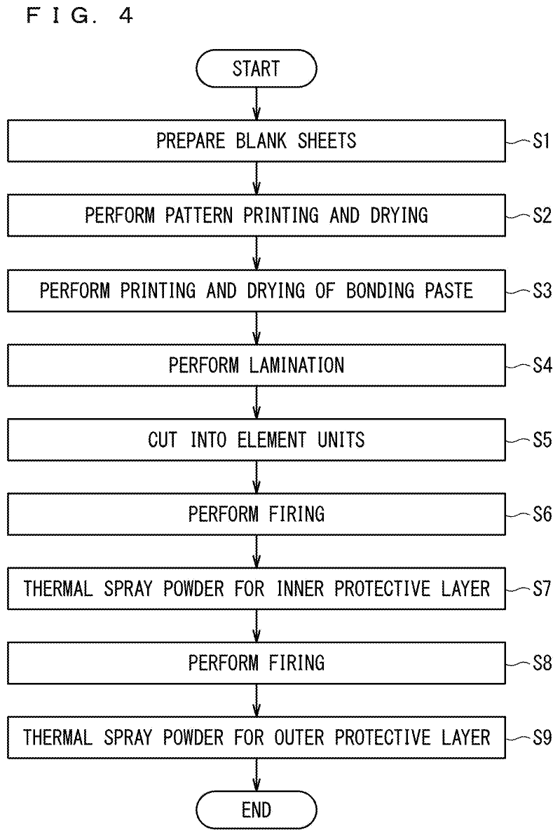

One example of a process of manufacturing the sensor element 10 having a configuration and features as described above will be described next. FIG. 4 is a flowchart of processing at the manufacture of the sensor element 10 by taking, an example, a case where the leading-end protective layer 2 includes the inner leading-end protective layer 2a and the outer leading-end protective layer 2b as illustrated in FIG. 3.

At the manufacture of the element base 1, a plurality of blank sheets (not illustrated) being green sheets containing the oxygen-ion conductive solid electrolyte, such as zirconia, as a ceramic component and having no pattern formed thereon are prepared first (step S1).

The blank sheets have a plurality of sheet holes used for positioning in printing and lamination. The sheet holes are formed to the blank sheets in advance prior to pattern formation through, for example, punching by a punching machine. Green sheets corresponding to a portion of the ceramic body 101 in which an internal space is formed also include penetrating portions corresponding to the internal space formed in advance through, for example, punching as described above. The blank sheets are not required to have the same thickness, and may have different thicknesses in accordance with corresponding portions of the element base 1 eventually formed.

After preparation of the blank sheets corresponding to the respective layers, pattern printing and drying are performed on the individual blank sheets (step S2). Specifically, a pattern of various electrodes, a pattern of the heater 150 and the insulating layer 151, a pattern of the electrode terminals 160, a pattern of the main surface protective layers 170, a pattern of internal wiring, which is not illustrated, and the like are formed. Application or placement of a sublimable material (vanishing material) for forming the first diffusion control part 110, the second diffusion control part 120, the third diffusion control part 130, and the fourth diffusion control part 140 is also performed at the time of pattern printing. In a case where the underlying layer is formed, a pattern to form the underlying layer is printed onto blank sheets to become an uppermost layer and a lowermost layer after lamination.

The patterns are printed by applying pastes for pattern formation prepared in accordance with the properties required for respective formation targets onto the blank sheets using known screen printing technology. A known drying means can be used for drying after printing.

After pattern printing on each of the blank sheets, printing and drying of a bonding paste are performed to laminate and bond the green sheets (step S3). The known screen printing technology can be used for printing of the bonding paste, and the known drying means can be used for drying after printing.

The green sheets to which an adhesive has been applied are then stacked in a predetermined order, and the stacked green sheets are crimped under predetermined temperature and pressure conditions to thereby form a laminated body (step S4). Specifically, crimping is performed by stacking and holding the green sheets as a target of lamination on a predetermined lamination jig, which is not illustrated, while positioning the green sheets at the sheet holes, and then heating and pressurizing the green sheets together with the lamination jig using a lamination machine, such as a known hydraulic pressing machine. The pressure, temperature, and time for heating and pressurizing depend on a lamination machine to be used, and these conditions may be determined appropriately to achieve good lamination. The pattern to form the underlying layer may be formed on the laminated body obtained in this manner.

After the laminated body is obtained as described above, the laminated body is cut out at a plurality of locations to obtain unit bodies eventually becoming the individual element bases 1 (step S5).

The unit bodies as obtained are then each fired at a firing temperature of approximately 1300° C. to 1500° C. (step S6). The element base 1 is thereby manufactured. That is to say, the element base 1 is generated by integrally firing the ceramic body 101 made of the solid electrolyte, the electrodes, and the main surface protective layers 170. Integral firing is performed in this manner, so that the electrodes each have sufficient adhesion strength in the element base 1.

After the element base 1 is manufactured in the above-mentioned manner, the inner leading-end protective layer 2a and the outer leading-end protective layer 2b are formed with respect to the element base 1. The inner leading-end protective layer 2a is formed by thermal spraying powder (alumina powder) for forming the inner leading-end protective layer prepared in advance at a location of the element base 1 as a target of formation of the inner leading-end protective layer 2a to have an intended thickness (step S7), and then firing the element base 1 on which an applied film has been formed in the above manner (step S8). The alumina powder for forming the inner leading-end protective layer contains alumina powder having predetermined particle size distribution and a pore-forming material at a ratio corresponding to a desired porosity, and the pore-forming material is pyrolyzed by firing of the element base 1 after thermal spraying to suitably form the inner leading-end protective layer 2a having a high porosity of 40% to 80%. Known technology is applicable to thermal spraying and firing.

The inner leading-end protective layer 2a can be caused to have different thicknesses on the side of the pump surface 1p, on the side of the heater surface 1h, and on the side of the leading end surface 101e, for example, by reduction in speed of thermal spraying, repeating of thermal spraying onto the same portion, and other methods at formation on a side on which the thickness is to be increased.

Upon formation of the inner leading-end protective layer 2a, powder (alumina powder) for forming the outer leading-end protective layer similarly prepared in advance and containing alumina powder having predetermined particle size distribution is thermal sprayed at a location of the element base 1 as a target of formation of the outer leading-end protective layer 2b to have an intended thickness (step S9) to thereby form the outer leading-end protective layer 2b having a desired porosity. The alumina powder for forming the outer leading-end protective layer does not contain the pore-forming material. Known technology is also applicable to the thermal spraying. Measures to be taken in a case where the outer leading-end protective layer 2b is caused to have different thicknesses on the side of the pump surface 1p, on the side of the heater surface 1h, and on the side of the leading end surface 101e are similar to those taken at formation of the inner leading-end protective layer 2a.

In a case where the leading-end protective layer 2 is provided as a single layer as illustrated in FIG. 2, the above-mentioned step S9 is unnecessary.

The sensor element 10 is obtained by the above-mentioned procedures. The sensor element 10 thus obtained is housed in a predetermined housing, and built into the body (not illustrated) of the gas sensor 100.

<Modifications>

The above-mentioned embodiment is targeted at a sensor element having three internal chambers, but the sensor element is not necessarily required to have a three-chamber structure. That is to say, the sensor element may have one internal chamber or two internal chambers.

The above-mentioned embodiment is based on the assumption that the unit layers constituting the leading-end protective layer 2 have a uniform thickness in the leading end portion 2e, but the thickness in the leading end portion 2e is sometimes not uniform depending on the shape of the leading-end protective layer 2. One example of such a case is a case where the thickness Tₚ on the side of the pump surface 1p or the thickness Tₕ on the side of the heater surface 1h is intentionally caused to be different from the thickness Tₑ on the side of the leading end surface 101e.

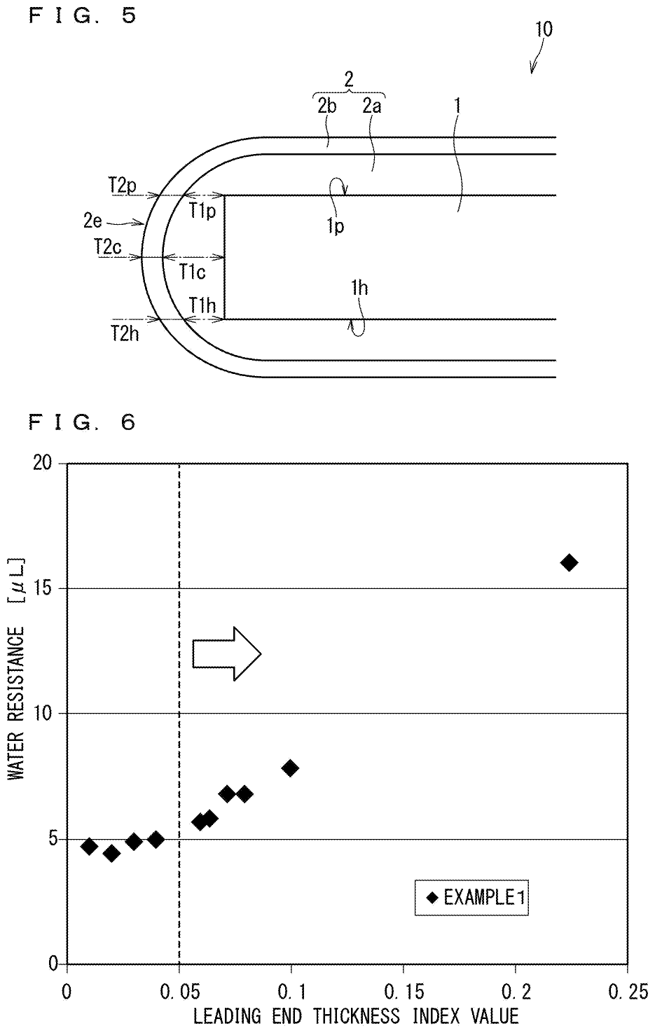

FIG. 5 illustrates a case where the leading-end protective layer 2 has the two-layer configuration, and has a non-uniform thickness. In such a case, after the size along the pump surface 1p of the element base 1, the size along the heater surface 1h of the element base 1, and the size at a location equidistant from the pump surface 1p and the heater surface 1h are specified, an average value of them may be used as a value of Tⱼ in the above-mentioned inequalities (2) to (4). In a case illustrated in FIG. 5, equations below are satisfied:

T₁=(T₁ₚ+T₁ₕ+T_{1c})/3; and

T₂=(T₂ₚ+T₂ₕ+T₂ₑ)/3.

In the above-mentioned embodiment, after thermal spraying of the powder for forming the inner leading-end protective layer in the step S7, firing is performed in the step S8, and then thermal spraying of the powder for forming the outer leading-end protective layer is performed in the step S9. Firing in the step S8 and thermal spraying in the step S9, however, may be performed in reverse order.

In the above-mentioned embodiment, the inner leading-end protective layer 2a and the outer leading-end protective layer 2b are each made of alumina, and the alumina powder is used as a thermal spraying material at formation of both of the layers, but they are not necessarily required to be made of alumina. The inner leading-end protective layer 2a and the outer leading-end protective layer 2b may be made of metallic oxide, such as zirconia (ZrO₂), spinel (MgAl₂O₄), and mullite (Al₆O1₃Si₂), in place of alumina. In this case, powder of the metallic oxide may be used as the thermal spraying material.

The above-mentioned embodiment is targeted at the sensor element 10 including the elongated planar element base 1 (the ceramic body 101) having the gas inlet 105 in the one end portion E1 thereof, but, even in a case where the gas inlet 105 is located in a side portion of the sensor element 1, similar effects to those obtained in the above-mentioned embodiment are expected as long as the inequalities (2) to (4) are satisfied.

### EXAMPLES

### Example 1

As Example 1, ten types of sensor elements 10 including leading-end protective layers 2 each being a single layer and having different thicknesses T₁ in the leading end portion 2e were manufactured, and water resistance in the leading end portion 2e of each of the sensor elements 10 was evaluated.

More particularly, two types of element bases 1 including an element base 1 having Lₚ of 0.91 mm, Lₕ of 0.41 mm, and Lₑ of 1.26 mm (hereinafter, a base sample a) and an element base 1 having Lₚ of 1.03 mm, Lₕ of 0.20 mm, and Lₑ of 0.38 mm (hereinafter, a base sample b) were prepared.

As for the leading-end protective layers 2 of the base sample a, the thickness T₁ in the leading end portion 2e was varied in seven levels of 50 μm, 100 μm, 150 μm, 200 μm, 300 μm, 400 μm, and 500 μm, and the porosity ρ₁ was varied in three levels of 20%, 25%, and 30%.

The leading-end protective layer 2 of the base sample b had a thickness T₁ in the leading end portion 2e of 380 μm, and had a porosity ρ₁ of 22%.

Water resistance was evaluated by applying a water droplet of 0.1 μL at a time to the side of the one end portion E1 of the sensor element 10 while measuring the pump current Ip0 through the main pump cell P1 in a state of each of the sensor elements 10 being heated by the heater 150 to approximately 500° C. to 900° C., and specifying the maximum amount of water causing no abnormality in an output of measurement.

The distance Lₑ in each of the sensor elements 10, the thickness T₁ and the porosity ρ₁ in the leading end portion 2e of the leading-end protective layer 2, the leading end thickness index value calculated based on them, and the result of evaluation of water resistance are shown in Table 1 as a list. FIG. 6 is a plot of the result of evaluation of water resistance according to Example 1 shown in Table 1 against the leading end thickness index value.

TABLE 1

| | LEADING-END | | LEADING END | WATER |
|---|---|---|---|---|
| Lₑ | PROTECTIVE LAYER | | THICKNESS | RESISTANCE |
| [mm] | T₁ [μm] | ρ₁ [%] | INDEX VALUE | [μL] |
| 1.26 | 400 | 25 | 0.079 | 6.8 |
| 1.26 | 100 | 25 | 0.020 | 4.4 |
| 1.26 | 300 | 25 | 0.060 | 5.7 |
| 1.26 | 50 | 25 | 0.010 | 4.7 |
| 1.26 | 200 | 25 | 0.040 | 5 |
| 1.26 | 150 | 25 | 0.030 | 4.9 |
| 0.38 | 380 | 22 | 0.224 | 16.0 |
| 1.26 | 500 | 25 | 0.099 | 7.8 |
| 1.26 | 400 | 20 | 0.063 | 5.8 |
| 1.26 | 300 | 30 | 0.071 | 6.8 |

As shown in Table 1, each of the sensor elements 10 having the leading end thickness index value satisfying the inequality (2) had water resistance of 5 μL or more.

It is understood from FIG. 6 that the leading end thickness index value has a positive correlation with water resistance irrespective of the difference in size of the element base 1, and it is also confirmed from FIG. 6 that water resistance of more than 5 μL can be obtained when the leading end thickness index value exceeds 0.05. This indicates that water resistance is suitably secured in the one end portion E1 of the sensor element 10 in which the gas inlet 105 is provided as long as the leading-end protective layer 2 is provided so that the leading end thickness index value satisfies the inequality (2).

### Example 2

As Example 2, 12 types of sensor elements 10 each including the leading-end protective layer 2 having the two-layer configuration of the inner leading-end protective layer 2a and the outer leading-end protective layer 2b were manufactured, and water resistance in the leading end portion 2e of each of the sensor elements 10 was evaluated.

More particularly, two types of element bases 1 including the base sample a as in Example 1 and an element base 1 having Lₚ of 0.71 mm, Lₕ of 0.17 mm, and Lₑ of 0.39 mm (hereinafter, a base sample c) were prepared.

As for the inner leading-end protective layers 2a of the base sample a, the thickness T₁ in the leading end portion 2e was varied in seven levels of 350 μm, 400 μm, 500 μm, 600 μm, 650 μm, 800 μm, and 850 μm, and the porosity ρ₁ was varied in seven levels of 35%, 40%, 50%, 55%, 60%, 65%, and 80%.

On the other hand, as for the outer leading-end protective layers 2b, the thickness T₂ in the leading end portion 2e was varied in three levels of 150 μm, 250 μm, and 350 μm, and the porosity ρ₂ was varied in three levels of 15%, 20%, and 25%.

The inner leading-end protective layer 2a of the base sample c had a thickness T₁ in the leading end portion 2e of 276 μm, and had a porosity ρ₁ of 16.2%. Furthermore, the outer leading-end protective layer 2b had a thickness T₂ in the leading end portion 2e of 232 μm, and had a porosity ρ₂ of 40.7%.

The distance Lₑ on the side of the leading end surface 101e, the thickness T₁ and the porosity ρ₁ of the inner leading-end protective layer 2a (“FIRST PROTECTIVE LAYER” in Table 2), the thickness T₂ and the porosity ρ₂ of the outer leading-end protective layer 2b (“SECOND PROTECTIVE LAYER” in Table 2), the leading end thickness index value calculated based on them, and the result of evaluation of water resistance are shown in Table 2 as a list.

TABLE 2

| | | | | | LEADING | |
|---|---|---|---|---|---|---|
| | | | | | END | |
| | FIRST | | SECOND | | THICK- | WATER |
| | PROTECTIVE | | PROTECTIVE | | NESS | RESIST- |
| Lₑ | LAYER | | LAYER | | INDEX | ANCE |
| [mm] | T₁ [μm] | ρ₁ [%] | T₂ [μm] | ρ₂ [%] | VALUE | [μL] |
| 1.26 | 400 | 50 | 250 | 25 | 0.208 | 14 |
| 1.26 | 650 | 40 | 250 | 25 | 0.256 | 20 |
| 1.26 | 400 | 40 | 250 | 25 | 0.177 | 11.2 |
| 1.26 | 500 | 40 | 250 | 25 | 0.208 | 16.3 |
| 0.39 | 276 | 16.2 | 232 | 40.7 | 0.357 | 20.4 |
| 1.26 | 800 | 55 | 250 | 25 | 0.399 | 43.2 |
| 1.26 | 800 | 35 | 250 | 25 | 0.272 | 30.9 |
| 1.26 | 800 | 80 | 250 | 25 | 0.558 | 20 |
| 1.26 | 600 | 60 | 350 | 25 | 0.355 | 25 |
| 1.26 | 850 | 60 | 250 | 25 | 0.454 | 30 |
| 1.26 | 600 | 60 | 250 | 15 | 0.315 | 20 |
| 1.26 | 350 | 65 | 150 | 20 | 0.204 | 20 |

As shown in Table 2, each of the sensor elements 10 had the leading end thickness index value satisfying the inequality (2), and had water resistance of 6 μL or more.

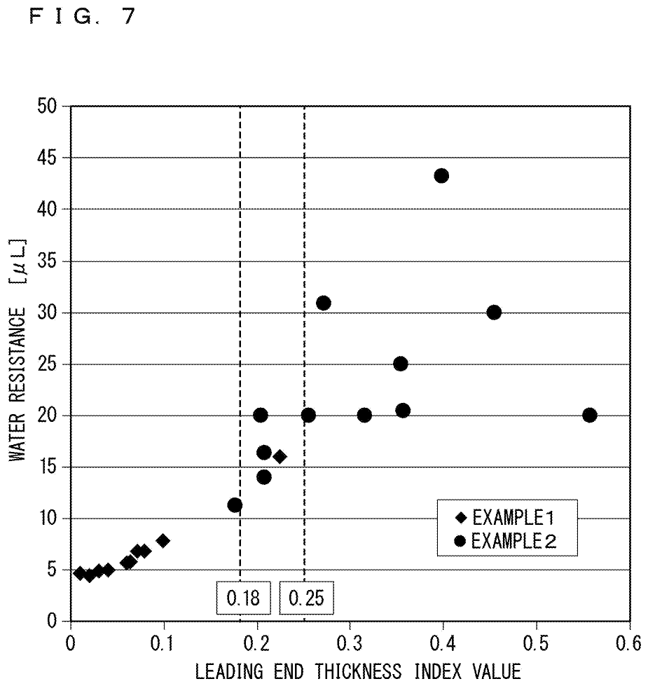

FIG. 7 is a plot of the result of evaluation of water resistance according to Example 2 shown in Table 2 against the leading end thickness index value along with the result of evaluation according to Example 1. As with FIG. 6, it is understood from FIG. 7 that the leading end thickness index value has a positive correlation with water resistance irrespective of the difference in size of the element base 1. This indicates that good water resistance is secured as long as each layer is provided so that the leading end thickness index value satisfies the inequality (2) even in a case where the leading-end protective layer 2 has the laminated structure of a plurality of unit layers.

In addition, it is confirmed from Table 2 and FIG. 7 that, from among the sensor elements 10 of Example 2, each of the sensor elements 10 having the leading end thickness index value satisfying the inequality (3) has good water resistance of more than 10 μL, and, further, each of the sensor elements 10 having the leading end thickness index value satisfying the inequality (4) has extremely good water resistance of more than 20 μL.

While the invention has been shown and described in detail, the foregoing description is in all aspects illustrative and not restrictive. It is therefore understood that numerous modifications and variations can be devised without departing from the scope of the invention.

What is claimed is:

1. A sensor element for a gas sensor, said sensor element comprising:
an element base being a ceramic structure, said element base having an end surface having a gas inlet through which a measurement gas is introduced into said element base, and including a sensing part for sensing a gas component to be measured and a heater for heating said sensor element; and
a leading-end protective layer disposed around an outer periphery of said element base in a predetermined range at least including said end surface, and being a porous layer including one or more unit layers, wherein
said leading-end protective layer is provided on said end surface to satisfy
$$\frac{1}{100000} \sum \frac{{T}_{j} \cdot {ρ}_{j}}{{L}_{e}} > 0.05 ( j = 1 \sim n ) \qquad$$
where Tⱼ (j=1 to n: n is a natural number) is a thickness in μm of a j-th unit layer of said leading-end protective layer from a side of said element base on said end surface, ρⱼ is a porosity in % of said j-th unit layer, and Lₑ is a distance in mm from said heater to said end surface.

2. The sensor element for said gas sensor according to claim 1, wherein
said sensor element has an elongated planar shape, and said end surface is a surface on a side of one leading end portion in a longitudinal direction of said sensor element.

3. The sensor element for said gas sensor according to claim 1, wherein
n=2, and
said leading-end protective layer is provided on said end surface to satisfy
$$\frac{1}{100000} \sum \frac{{T}_{j} \cdot {ρ}_{j}}{{L}_{e}} > 0.18 ( j = 1 , 2 ) .$$

4. The sensor element for said gas sensor according to claim 3, wherein
300 μm≤T₁≤850 μm,
40%≤ρ₁≤80%,
150 μm≤T₂≤350 μm,
15%≤ρ₂≤40%, and
0.35 mm≤Lₑ≤1.3 mm.

5. The sensor element for said gas sensor according to claim 4, wherein said leading-end protective layer is provided on said end surface to satisfy
$$\frac{1}{100000} \sum \frac{{T}_{j} \cdot {ρ}_{j}}{{L}_{e}} > 0.25 ( j = 1 , 2 ) .$$

6. The sensor element for said gas sensor according to claim 5, wherein
300 μm≤T₁≤850 μm,
50%≤ρ₁≤80%,
250 μm≤T₂≤350 μm,
15%≤ρ₂≤40%, and
0.35 mm≤Lₑ≤1.3 mm.

7. The sensor element for said gas sensor according to claim 2, wherein
n=2, and
said leading-end protective layer is provided on said end surface to satisfy
$$\frac{1}{100000} \sum \frac{{T}_{j} \cdot {ρ}_{j}}{{L}_{e}} > 0.18 ( j = 1 , 2 ) .$$

8. The sensor element for said gas sensor according to claim 7, wherein
300 μm≤T₁≤850 μm,
40%≤ρ₁≤80%,
150 μm≤T₂≤350 μm,
15%≤ρ₂≤40%, and
0.35 mm≤Lₑ≤1.3 mm.

9. The sensor element for said gas sensor according to claim 8, wherein said leading-end protective layer is provided on said end surface to satisfy
$$\frac{1}{100000} \sum \frac{{T}_{j} \cdot {ρ}_{j}}{{L}_{e}} > 0.25 ( j = 1 , 2 ) .$$

10. The sensor element for said gas sensor according to claim 9, wherein
300 μm≤T₁≤850 μm,
50%≤ρ₁≤80%,
250 μm≤T₂≤350 μm,
15%≤ρ₂≤40%, and
0.35 mm≤Lₑ≤1.3 mm.
